(19) United States
(12) Patent Application Publication
(10) Pub. No.: US 2026/0230125 A1
(43) Pub. Date: Aug. 6, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Jing Wang, Haidian District, Beijing (CN); Lan Chen, Haidian District, Beijing (CN)

(73) Assignee: NTT DOCOMO, INC., Tokyo (JP)

(21) Appl. No.: 19/114,117

(22) PCT Filed: Sep. 28, 2022
(86) PCT No.: PCT/JP2022/036302

§ 371 Date: Mar. 21, 2025

(51) Int. Cl. H04B 7/0456; H04W 72/1268

(52) U.S. Cl. CPC H04B 7/0456; H04W 72/1268

(57) ABSTRACT

A terminal according to one aspect of the present disclosure includes a receiving section that receives configuration information related to a codebook subset only for a fully-coherent precoder or a codebook subset only for a partial-coherent precoder, and a control section that determines a precoding matrix for transmission of a physical uplink shared channel, based on the codebook subset indicated by the configuration information and downlink control information for scheduling the physical uplink shared channel. According to one aspect of the present disclosure, it is possible to appropriately control UL transmission using more than four antenna ports.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long Term Evolution (LTE) have been drafted for the purpose of further increasing high speed data rates, providing lower latency and so on (Non-Patent Literature 1). In addition, for the purpose of further high capacity, advancement and the like of LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V 8.12.0 “Evolved Universal Terrestrial Radio Access (E-UTRA) and Evolved Universal Terrestrial Radio Access Network (E-UTRAN); Overall description; Stage 2 (Release 8),” April, 2010.

### SUMMARY OF INVENTION

### Technical Problem

In Rel-15 NR, uplink (UL) Multi Input Multi Output (MIMO) transmission with up to four layers is supported. For future NR, it is studied to support UL transmission with layers the number of which is more than four, to achieve higher spectrum efficiency.

For example, for Rel-18 NR, 6-rank maximum transmission using six antenna ports, 6-rank or 8-rank transmission using eight antenna ports, and the like are studied.

In existing standards, it is necessary to support unified design of a precoding matrix table (codebook), unified design of notification of downlink control information related to determination of a precoding matrix, and the like.

However, such unified design described above, for example, limits individual preferable configurations of precoding matrices and causes an increase in bit size of downlink control information, which may suppress an increase in communication throughput.

Thus, an object of the present disclosure is to provide a terminal, a radio communication method, and a base station that enable appropriate control of UL transmission using more than four antenna ports.

### Solution to Problem

A terminal according to one aspect of the present disclosure includes a receiving section that receives configuration information related to a codebook subset only for a fully-coherent precoder or a codebook subset only for a partial-coherent precoder, and a control section that determines a precoding matrix for transmission of a physical uplink shared channel, based on the codebook subset indicated by the configuration information and downlink control information for scheduling the physical uplink shared channel.

### Advantageous Effects of Invention

According to one aspect of the present disclosure, it is possible to appropriately control UL transmission using more than four antenna ports.

### BRIEF DESCRIPTION OF DRAWINGS

FIG. 1 is a diagram to show an example of a table of precoding matrices W for single-layer (rank 1) transmission using four antenna ports when a transform precoder is disabled, in Rel-16 NR.

FIG. 2 is a diagram to show a table of precoding matrices W for 2-layer (rank 2) transmission using four antenna ports when a transform precoder is disabled, in Rel-16 NR.

FIG. 3 is a diagram to show an example of a table of precoding matrices W for 3-layer (rank 3) transmission using four antenna ports when a transform precoder is disabled, in Rel-16 NR.

FIG. 4 shows an example of a table of precoding matrices W for 4-layer (rank 4) transmission using four antenna ports when a transform precoder is disabled, in Rel-16 NR.

FIG. 5A is a diagram to show an example of a table of precoding matrices W for single-layer (rank 1) transmission using two antenna ports, in Rel-16 NR. FIG. 5B is a diagram to show an example of a table of precoding matrices W for 2-layer (rank 2) transmission using two antenna ports when transform precoding is disabled, in Rel-16 NR.

FIG. 6 is a diagram to show an example of a correspondence between values of a precoding information and number of layers field and the numbers of layers and TPMIs in Rel-16 NR.

FIGS. 7A to 7C are diagrams to show an SRI indication(s) or a second SRI indication(s) at the time of codebook based PUSCH transmission in Rel. 17.

FIG. 8 is a diagram to show examples of an antenna layout with eight antenna ports.

FIGS. 9A to 9C are diagrams to show examples of implementation of 8-port transmission.

FIG. 10A is a diagram to show an example of new 3-layer precoders obtained by reusing an existing 4-port partial-coherent precoder. FIG. 10B is a diagram to show a 6-layer precoder constituted of four layers from one coherent group and two layers from another coherent group.

FIG. 11A is a diagram to show an example of 4-layer precoders each constituted of two layers from one coherent group and two layers from another coherent group. FIG. 11B is a diagram to show an example of an 8-layer precoders constituted of four two-layer precoders from four coherent groups.

FIGS. 12A and 12B are diagrams to show examples of fields of DCI necessary to indicate a precoding matrix.

FIG. 13 is a diagram to show examples of a combination of the numbers of layers corresponding to a precoding matrix.

FIG. 14 is a diagram to show an example of a correspondence between values of a precoding information field and combinations of the numbers of layers and TPMI indices.

FIG. 15A is a diagram to show an example of fields of DCI necessary to indicate a precoding matrix. FIG. 15B is a diagram to show an example of a correspondence between values of a rank combination indication field and combinations of the numbers of layers.

FIGS. 16A to 16C are diagrams to show examples of a table of precoding matrices W for 1-layer (rank 1) transmission using eight antenna ports when transform precoding is disabled, according to a second embodiment. FIGS. 16D to 16F are diagrams to show examples of a table of precoding matrices W for 8-layer (rank 8) transmission using eight antenna ports when transform precoding is disabled, according to the second embodiment.

FIGS. 17A and 17B are diagrams to show examples of a table of precoding matrices W for 8-layer (rank 8) transmission using eight antenna ports when transform precoding is disabled, according to the second embodiment.

FIGS. 18A to 18F are diagrams to show examples of a correspondence between values of a precoding information and number of layers field and specified contents according to a third embodiment.

FIG. 19 is a diagram to show an example of the correspondence between values of a precoding information and number of layers field and specified contents, according to the third embodiment.

FIG. 20 is a diagram to show an example of a schematic structure of a radio communication system according to one embodiment.

FIG. 21 is a diagram to show an example of a structure of a base station according to one embodiment.

FIG. 22 is a diagram to show an example of a structure of a user terminal according to one embodiment.

FIG. 23 is a diagram to show an example of a hardware structure of the base station and the user terminal according to one embodiment.

FIG. 24 is a diagram to show an example of a vehicle according to one embodiment.

### DESCRIPTION OF EMBODIMENTS

### Control of SRS and PUSCH Transmission

In Rel-15 NR, a terminal (user terminal, user equipment (UE)) may receive information to be used for transmission of a reference signal for measurement (for example, sounding reference signal (SRS)) (SRS configuration information, for example, a parameter in an RRC control element “SRS-Config”).

Specifically, the UE may receive at least one of information related to one or a plurality of SRS resource sets (SRS resource set information, for example, an RRC control element “SRS-ResourceSet”) and information related to one or a plurality of SRS resources (SRS resource information, for example an RRC control element “SRS-Resource”).

One SRS resource set may be related to a certain number of SRS resources (may group the certain number of SRS resources). Each SRS resource may be identified by an SRS resource indicator (SRI) or an SRS resource ID (Identifier).

The SRS resource set information may include an SRS resource set ID (SRS-ResourceSetId), a list of SRS resource IDs (SRS-ResourceId) used in the resource set, an SRS resource type, and information of SRS usage.

Here, the SRS resource type may indicate any one of a periodic SRS (P-SRS), a semi-persistent SRS (SP-SRS), and aperiodic CSI (Aperiodic SRS (A-SRS)). Note that the UE may periodically (or, after activation, periodically) transmit the P-SRS and the SP-SRS, and may transmit the A-SRS, based on an SRS request of DCI.

The usage (RRC parameter “usage,” L1 (Layer-1) parameter “SRS-SetUse”) may be, for example, beam management (beamManagement), codebook (CB), non-codebook (noncodebook (NCB)), antenna switching, or the like. An SRS with codebook or non-codebook usage may be used to determine a precoder for codebook based or non-codebook based uplink shared channel (Physical Uplink Shared Channel (PUSCH)) transmission based on an SRI.

For example, in a case of codebook based transmission (codebook-based transmission), the UE may determine a precoder (precoding matrix) for the PUSCH transmission, based on an SRI, a transmitted rank indicator (TRI), and a transmitted precoding matrix indicator (TPMI). In a case of non-codebook based transmission (non-codebook-based transmission), the UE may determine a precoder for the PUSCH transmission, based on an SRI.

The SRS resource information may include an SRS resource ID (SRS-ResourceId), the number of SRS ports, an SRS port number, a transmission Comb, SRS resource mapping (for example, a time and/or frequency resource location, resource offset, a resource periodicity, the number of repetitions, the number of SRS symbols, an SRS bandwidth, or the like), hopping-related information, an SRS resource type, a sequence ID, SRS spatial relation information, and the like.

The SRS spatial relation information (for example, an RRC information element “spatialRelationInfo”) may indicate information about a spatial relation between a certain reference signal and an SRS. The certain reference signal may be at least one of a synchronization signal/broadcast channel (Synchronization Signal/Physical Broadcast Channel (SS/PBCH)) block, a channel state information reference signal (CSI-RS), and an SRS (for example, another SRS). The SS/PBCH block may be referred to as a synchronization signal block (SSB).

The SRS spatial relation information may include, as an index of the above-described certain reference signal, at least one of an SSB index, a CSI-RS resource ID, and an SRS resource ID.

Note that, in the present disclosure, an SSB index, an SSB resource ID, and an SSB Resource Indicator (SSBRI) may be interchangeably interpreted. A CSI-RS index, a CSI-RS resource ID, and a CSI-RS Resource Indicator (CRI) may be interchangeably interpreted. An SRS index, an SRS resource ID, and an SRI may be interchangeably interpreted.

The SRS spatial relation information may include a serving cell index, a BWP index (BWP ID), and the like corresponding to the above-described certain reference signal.

Regarding a certain SRS resource, when spatial relation information related to an SSB or CSI-RS and an SRS is configured, the UE may transmit the SRS resource by using the same spatial domain filter (spatial domain transmission filter) as a spatial domain filter (spatial domain reception filter) for reception of the SSB or CSI-RS. In this case, the UE may assume that a UE receive beam of the SSB or CSI-RS and a UE transmit beam of the SRS are the same.

Regarding a certain SRS (target SRS) resource, when spatial relation information related to another SRS (reference SRS) and the SRS (target SRS) is configured, the UE may transmit the target SRS resource by using the same spatial domain filter (spatial domain transmission filter) as a spatial domain filter (spatial domain transmission filter) for transmission of the reference SRS. In other words, in this case, the UE may assume that a UE transmit beam of the reference SRS and a UE transmit beam of the target SRS are the same.

The UE may determine, based on a value of a certain field (for example, an SRS resource indicator (SRI) field) in DCI (for example, DCI format 0_1), a spatial relation for a PUSCH scheduled by the DCI. Specifically, the UE may use, for PUSCH transmission, spatial relation information (for example, an RRC information element “spatialRelationInfo”) for an SRS resource determined based on the value of the certain field (for example, the SRI).

In Rel-15/16 NR, when codebook based transmission is used for a PUSCH, the UE may be configured with an SRS resource set including two SRS resources at maximum with codebook usage, by RRC, and may be indicated with one of the two SRS resources at maximum by DCI (1-bit SRI field). A transmit beam for the PUSCH results in being indicated by an SRI field.

The UE may determine a TPMI and the number of layers (transmission rank) for PUSCH, based on the precoding information and number of layers field (referred to as a precoding information field below). The UE may select a precoder, based on the TPMI, the number of layers, and the like, from a codebook for uplink for the number of ports same as the number of SRS ports indicated by a higher layer parameter “nrofSRS-Ports” configured for an SRS resource indicated by the SRI field.

In Rel-15/16 NR, when non-codebook based transmission is used for a PUSCH, the UE may be configured with an SRS resource set including four SRS resources at maximum with non-codebook usage, by RRC, and may be indicated with one or more of the four SRS resources at maximum by DCI (2-bit SRI field).

The UE may determine the number of layers (transmission rank) for the PUSCH, based on the SRI field. For example, the UE may determine that the number of SRS resources indicated by the SRI field is the same as the number of layers for the PUSCH. The UE may calculate a precoder for the SRS resource.

When a CSI-RS related to the SRS resource (or SRS resource set to which the SRS resource belongs) (which may be referred to as an associated CSI-RS) is configured in a higher layer, a transmit beam for the PUSCH may be calculated based on (measurement of) the configured related CSI-RS. Otherwise, a transmit beam for the PUSCH may be indicated by an SRI.

Note that the UE may be configured with whether to use codebook based PUSCH transmission or use non-codebook based PUSCH transmission by a higher layer parameter “txConfig” indicating a transmission scheme. The parameter may indicate a value of “codebook” or “non-codebook (nonCodebook).”

In the present disclosure, a codebook based PUSCH (codebook based PUSCH transmission, codebook based transmission) may mean a PUSCH when the UE is configured with “codebook” as a transmission scheme. In the present disclosure, a non-codebook based PUSCH (non-codebook based PUSCH transmission, non-codebook based transmission) may mean a PUSCH when the UE is configured with “non-codebook” as a transmission scheme.

### Determination of PUSCH Precoder in Codebook (CB) Based Transmission

As described above, in a case of codebook (CB) based transmission, a UE may determine a precoder for PUSCH, based on an SRI, a TRI, a TPMI, and the like.

The UE may be notified of the SRI, the TRI, the TPMI, and the like by using downlink control information (DCI). The SRI may be indicated by an SRS Resource Indicator field (SRI field) of the DCI or may be indicated by a parameter “srs-ResourceIndicator” included in an RRC information element “ConfiguredGrantConfig” for a configured grant PUSCH.

The TRI and the TPMI may be indicated by a precoding information and number of layers field (“Precoding information and number of layers” field) of the DCI. The precoding information and number of layers field is also referred to as a precoding information field, for simplicity.

The UE may report UE capability information related to a precoder type and be configured, by a base station, with the precoder type based on the UE capability information by higher layer signaling. The UE capability information may be precoder type information to be used by the UE in PUSCH transmission (which may be indicated by an RRC parameter “pusch-TransCoherence,” for example).

The UE may determine a precoder to be used for the PUSCH transmission, based on precoder type information (for example, an RRC parameter “codebookSubset”) included in PUSCH configuration information notified by higher layer signaling (for example, a “PUSCH-Config” information element of RRC signaling). The UE may be configured with a subset of PMIs indicated by the TPMI, by codebookSubset.

Note that the precoder type may be indicated by any of or a combination of at least two of fully coherent (full coherent), partially coherent (partial coherent), and non-coherent (non coherent) (which may be indicated, for example, by a parameter such as “fullyAndPartialAndNonCoherent” or “partialAndNonCoherent”).

For example, an RRC parameter “pusch-TransCoherence” indicating a UE capability may indicate fully coherent (fullCoherent), partial coherent (partialCoherent), or non-coherent (nonCoherent). An RRC parameter “codebookSubset” may indicate “fullyAndPartialAndNonCoherent,” “partialAndNonCoherent,” or “nonCoherent.”

Fully coherent may mean that all the antenna ports to be used for transmission are synchronized (which may be expressed as being able to be matched in terms of phase, being able to perform phase control for each coherent antenna port, being able to appropriately apply a precoder for each coherent antenna port, and the like). Partial coherent may mean that some ports of the antenna ports to be used for transmission are synchronized but the ports and the other ports are not synchronized. Non-coherent may mean that the antenna ports to be used for transmission are not synchronized.

Note that a UE that supports the precoder type, fully coherent, may be assumed to support the precoder types, partial coherent and non-coherent. A UE that supports the precoder type, partial coherent, may be assumed to support the precoder type, non-coherent.

In the present disclosure, a precoder type, coherency, PUSCH transmission coherence, a coherent type, a coherence type, a codebook type, a codebook subset, a codebook subset type, and the like may be interchangeably interpreted.

The UE may determine a precoding matrix corresponding to the TPMI index obtained from DCI for scheduling UL transmission (for example, DCI format 0_1, this similarly applies below), from a plurality of precoders (which may be referred to as a precoding matrix, a codebook, and the like) for CB based transmission.

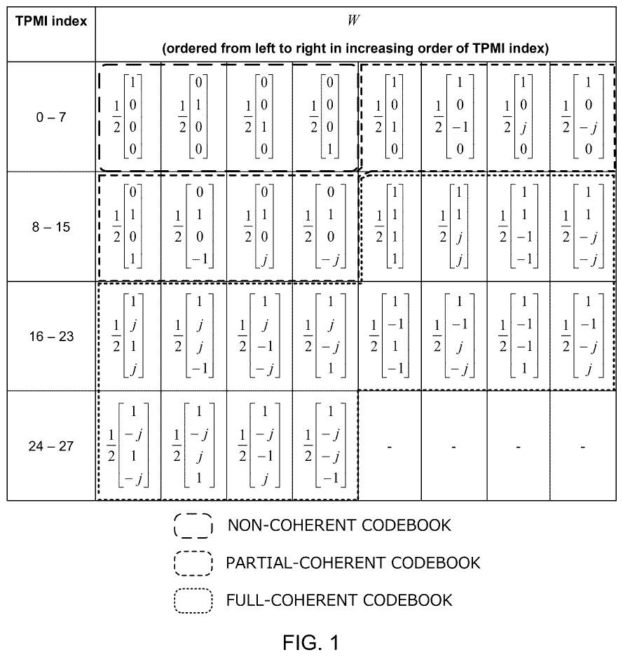

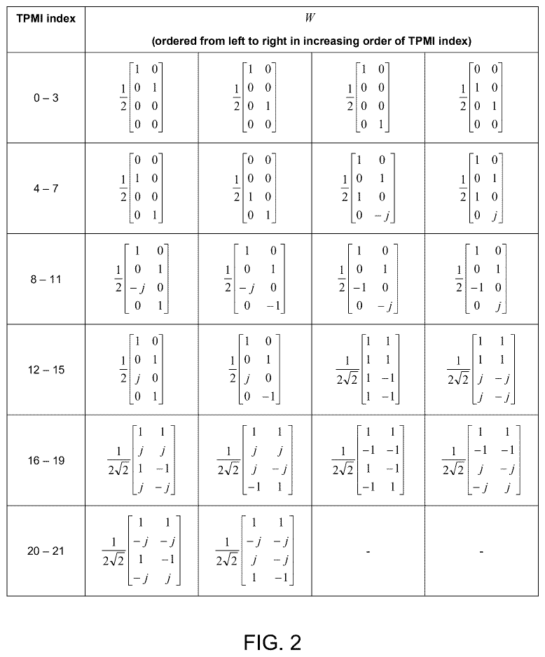

FIG. 1 is a diagram to show an example of association between codebook subsets and TPMI indices. FIG. 1 corresponds to a table of precoding matrices W for single-layer (rank 1) transmission using four antenna ports when transform precoding (which may be referred to as a transform precoder) is disabled, in Rel-16 NR. FIG. 1 shows corresponding W in ascending order of TPMI indices from left to right (this similarly applies to FIG. 2).

A correspondence (which may be referred to as a table) showing W corresponding to TPMI indices as shown in FIG. 1 is also referred to as a codebook. Part of this codebook is also referred to as a codebook subset.

In FIG. 1, when a codebook subset (codebookSubset) is fullyAndPartialAndNonCoherent, the UE is notified of a TPMI (TPMI index) of any of 0 to 27 for the single-layer transmission. When the codebook subset is partialAndNonCoherent, the UE is configured with a TPMI of any of 0 to 11 for the single-layer transmission. When the codebook subset is nonCoherent, the UE is configured with a TPMI of any of 0 to 3 for the single-layer transmission.

In FIG. 1, when a TPMI of any of 0 to 3 is notified, a non-coherent precoder is applied. When a TPMI of any of 4 to 11 is notified, a partial-coherent precoder is applied. When a TPMI of any of 12 to 27 is notified, a fully-coherent precoder is applied.

FIG. 2 corresponds to a table of individual precoding matrices W for 2-layer to 4-layer (rank 2 to 4) transmission using two antenna ports when transform precoding is disabled, in Rel-16 NR.

According to FIG. 2, a TPMI of which the UE is notified for 2-layer transmission is any of 0 to 21 (codebook subset corresponds to fullyAndPartialAndNonCoherent), any of 0 to 13 (codebook subset corresponds to partialAndNonCoherent), or any of 0 to 5 (codebook subset corresponds to nonCoherent).

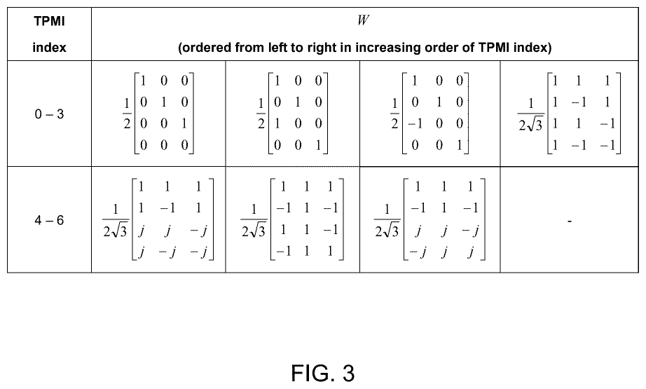

According to FIG. 3, a TPMI of which the UE is notified for 3-layer transmission is any of 0 to 6 (codebook subset corresponds to fullyAndPartialAndNonCoherent), any of 0 to 2 (codebook subset corresponds to partialAndNonCoherent), or 0 (codebook subset corresponds to nonCoherent).

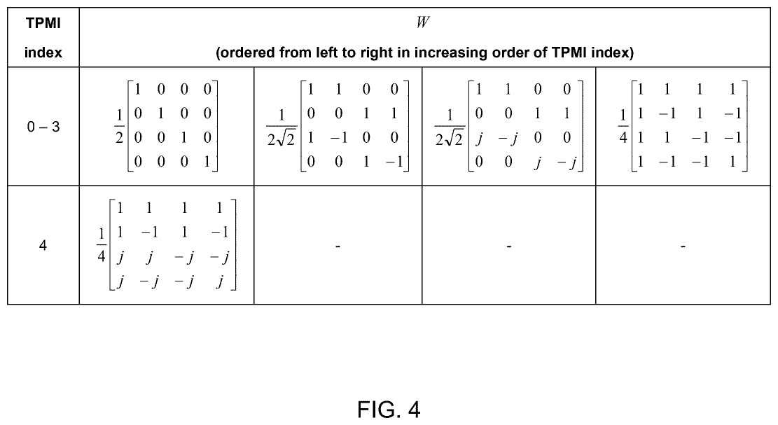

According to FIG. 4, a TPMI of which the UE is notified for 4-layer transmission is any of 0 to 4 (codebook subset corresponds to fullyAndPartialAndNonCoherent), any of 0 to 2 (codebook subset corresponds to partialAndNonCoherent), or 0 (codebook subset corresponds to nonCoherent).

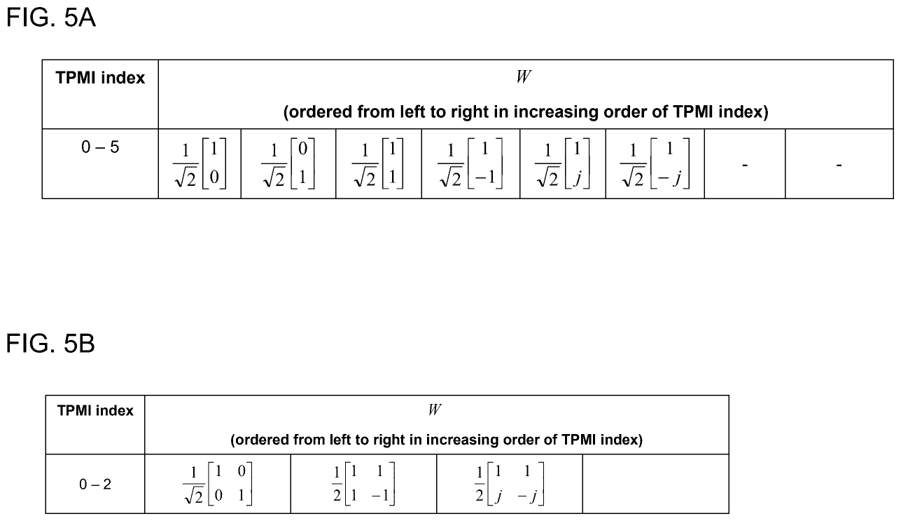

FIG. 5A corresponds to a table of precoding matrices W for single-layer (rank 1) transmission using two antenna ports in Rel-16 NR. FIG. 5B corresponds to a table of precoding matrices W for 2-layer (rank 2) transmission using two antenna ports when transform precoding is disabled, in Rel-16 NR.

According to FIG. 5A, a TPMI of which the UE is notified for 2-port single-layer transmission is any of 0 to 5 (codebook subset corresponds to fullyAndPartialAndNonCoherent) or either 0 or 1 (codebook subset corresponds to nonCoherent). When a TPMI of either 0 or 1 is notified, a non-coherent precoder is applied. When a TPMI of any of 2 to 5 is notified, a fully-coherent precoder is applied.

According to FIG. 5B, a TPMI of which the UE is notified for 2-port 2-layer transmission is any of 0 to 2 (codebook subset corresponds to fullyAndPartialAndNonCoherent) or 0 (codebook subset corresponds to nonCoherent).

Note that a precoding matrix having only one non-zero element of each column may be referred to as a non-coherent codebook. A precoding matrix having a certain number of non-zero elements of each column (larger than 1 but not all the elements of the column) may be referred to as a partial-coherent codebook. A precoding matrix having all the elements of each column being non-zero may be referred to as a full-coherent codebook.

A non-coherent codebook and a partial-coherent codebook may be referred to as an antenna selection precoder, an antenna port selection precoder, and the like. For example, a non-coherent codebook (non-coherent precoder) may be referred to as a 1-port selection precoder, a 1-port port selection precoder, and the like. A partial-coherent codebook (partial-coherent precoder) may be referred to as an x-port selection precoder (x being an integer larger than 1), an x-port port selection precoder, and the like. A full-coherent codebook may be referred to as a non-antenna selection precoder, all-port precoder, and the like. In the present disclosure, a codebook, a codebook subset, and a precoder may be interchangeably interpreted.

Note that, in the present disclosure, the partial-coherent codebook may correspond to the codebook obtained by removing a codebook corresponding to a TPMI indicated for the UE configured with a non-coherent codebook subset (for example, an RRC parameter “codebookSubset” =“nonCoherent”), from codebooks (precoding matrices) corresponding to TPMIs indicated by DCI for codebook based transmission for the UE configured with a partial-coherent codebook subset (for example, an RRC parameter “codebookSubset”=“partialAndNonCoherent”) (in other words, a codebook with TPMIS=4 to 11 in a case of single-layer transmission with 4 antenna ports).

Note that, in the present disclosure, the full-coherent codebook may correspond to the codebook obtained by removing a codebook corresponding to a TPMI indicated for the UE configured with a partial-coherent codebook subset (for example, an RRC parameter “codebookSubset”=“partialAndNonCoherent”), from codebooks (precoding matrices) corresponding to TPMIs indicated by DCI for codebook based transmission for the UE configured with a fully-coherent codebook subset (for example, an RRC parameter “codebookSubset”=“fullyAndPartialAndNonCoherent”) (in other words, a codebook with TPMIs=12 to 27 in a case of single-layer transmission with 4 antenna ports).

Note that, as can be seen from FIGS. 5A and 5B, since there is no partial-coherent precoder for 2-antenna-port transmission, a configuration that a codebook subset corresponds to partialAndNonCoherent need not be applied for 2 antenna ports.

### Precoding Information Field

As described above, a UE may determine a TPMI and the number of layers (transmission rank) for a PUSCH, based on the precoding information field of DCI (for example, DCI format 0_1/0_2) for scheduling the PUSCH.

For a codebook based PUSCH, the number of bits of a precoding information field may be determined (may vary) based on configuration of enabled or disabled of a transform precoder for PUSCH (for example, a higher layer parameter transformPrecoder), configuration of a codebook subset for PUSCH (for example, a higher layer parameter codebookSubset), configuration of the maximum number of layers for PUSCH (for example, a higher layer parameter maxRank), configuration of uplink full power transmission for PUSCH (for example, a higher layer parameter ul-FullPowerTransmission), the number of antenna ports for PUSCH, and the like.

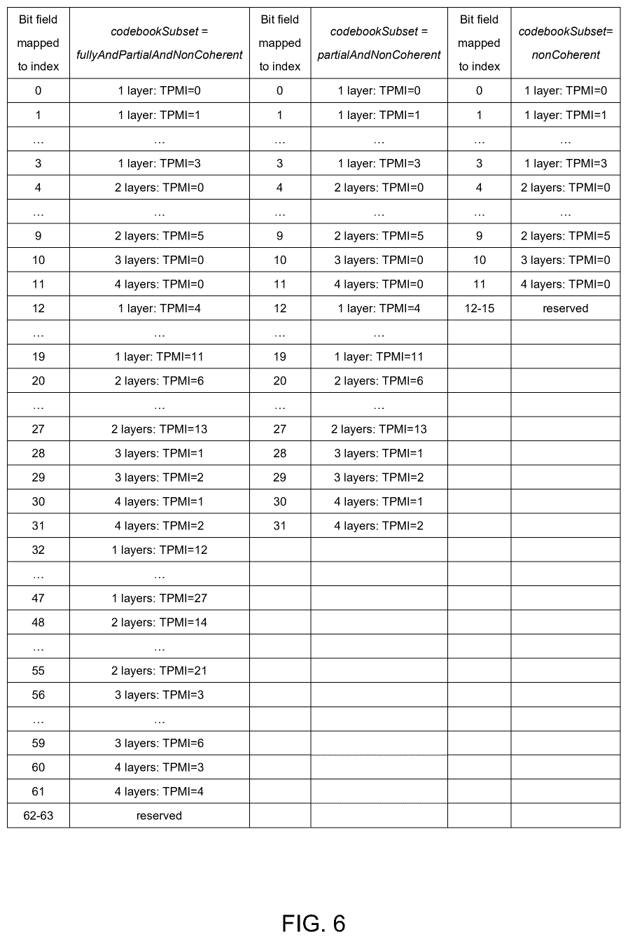

FIG. 6 is a diagram to show an example of a correspondence between values of a precoding information and number of layers field and the numbers of layers and TPMIs in Rel-16 NR. The correspondence of this example is a correspondence for four antenna ports in a case where a transform precoder is configured at disabled, the maximum rank (maxRank) is configured at 2, 3, or 4, and also uplink full power transmission is not configured, is configured at full power mode 2 (fullpowerMode2), or is configured at full power (fullpower), but is not restrictive. Note that it is apparent that those skilled in the art can understand that the “bit field mapped to index” shown in FIG. 6 indicates values of the precoding information and number of layers field.

In FIG. 6, the precoding information field is of 6 bits when fully-coherent (fullyAndPartialAndNonCoherent) codebook subset is configured for a UE, is of 5 bits when a partial-coherent (partialAndNonCoherent) codebook subset is configured for a UE, and is of 4 bits when a non-coherent (nonCoherent) codebook subset is configured for a UE.

Note that, as shown in FIG. 6, the number of layers and a TPMI corresponding to a value of a precoding information field may be the same (common) irrespective of a codebook subset configured for a UE. For example, in FIG. 6, the values 0 to 11 (=0 to 11) of the precoding information field may indicate the same number of layers and TPMI for fully-coherent (fullyAndPartialAndNonCoherent), partial-coherent (partialAndNonCoherent), and non-coherent (nonCoherent) codebook subsets. In FIG. 6, the values 0 to 31 (=0 to 31) of the precoding information field may indicate the same number of layers and TPMI for fully-coherent (fullyAndPartialAndNonCoherent) and partial-coherent (partialAndNonCoherent) codebook subsets.

Note that the precoding information field may be of 0 bits for a non-codebook based PUSCH. The precoding information field may be of 0 bits for a 1-antenna-port codebook based PUSCH.

### SRS Configuration for Codebook Based PUSCH

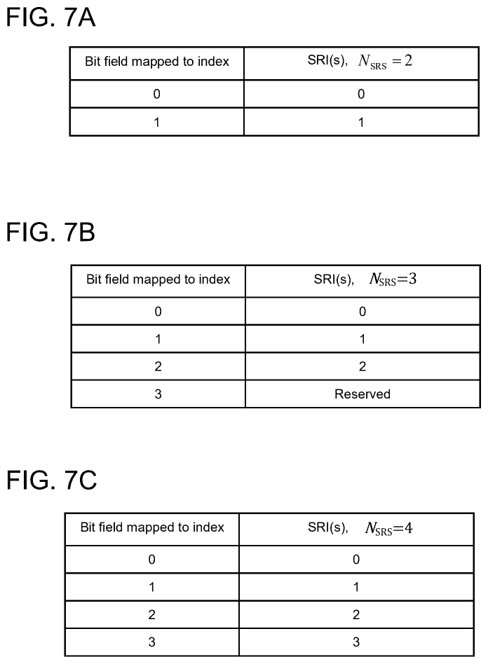

FIG. 7A is a diagram to show SRI indications or second SRI indications at the time of codebook based PUSCH transmission in a case where ul-FullPowerTransmission is not configured or a case of ul-FullPowerTransmission =fullpowerModel, ul-FullPowerTransmission =fullpowerMode2, or ul-FullPowerTransmission =fullpower and N_{SRS}=2, in Rel. 17. FIG. 7B is a diagram to show SRI indications or second SRI indications for codebook based PUSCH transmission in a case of ul-FullPowerTransmission =fullpowerMode2 and N_{SRS}=3, in Rel. 17. FIG. 7C is a diagram to show SRI indications or second SRI indications for codebook based PUSCH transmission in a case of ul-FullPowerTransmission =fullpowerMode2 and N_{SRS}=4, in Rel. 17.

An SRI indication corresponds to an SRS resource indicator field of DCI, and a second SRI indication corresponds to a Second SRS resource indicator field of DCI. An SRS resource set indicator field is of 2 bits in a case of txConfig=nonCodeBook, a case of being configured by srs-ResourceSetToAddModList, and a case where two SRS resource sets related to usage “nonCodeBook” are present, or in a case of txConfig=codebook, a case of being configured by srs-ResourceSetToAddModList, and a case where two SRS resource sets related to usage “codebook” are present. Otherwise, the SRS resource set indicator field is of 0 bits.

In a case of the higher layer parameter txConfig=codebook, the SRS resource indicator field is of [log₂ (N_{SRS})] bits in accordance with FIGS. 7A to 7C. N_{SRS} denotes the number of SRS resources configured in an SRS resource set indicated by the SRS resource set indicator field (if present). Otherwise, N_{SRS} denotes the number of SRS resources configured in an SRS resource set configured by a higher layer parameter srs-ResourceSetToAddModList and related to a higher layer parameter usage of the value ‘codeBook.’

In codebook based transmission, a PUSCH is scheduled by DCI format 0_0, DCI format 0_1, or DCI format 0_2 or configured semi-fixedly. Only one or two SRS resource sets can be configured in SRS-ResourceSetToAddModList having the higher layer parameter usage of “codebook” of SRS-ResourceSet. Only one or two SRS resource sets can be configured in srs-ResourceSetToAddModListDCI-0-2 having the higher layer parameter usage “codebook” of SRS-ResourceSet.

When the higher layer parameter usage of SRS-ResourceSet is configured at “codebook” and two SRS resource sets are configured in srs-ResourceSetToAddModList or srs-ResourceSetToAddModListDCI-0-2, one or two SRIs and one or two TPMIs are given respectively by two SRS resource indicator fields and two precoding information fields.

The UE applies the indicated SRI(s) and TPMI(s) to one or more PUSCH repetitions according to SRS resource sets to which PUSCH repetitions are related. When two SRS resource sets are configured by SRS-ResourceSetToAddModList or srs-ResourceSetToAddModListDCI-0-2 and the higher layer parameter usage of SRS-ResourceSet is configured at “codebook,” the UE does not expect that different numbers of SRS resources are configured in the two SRS resource sets.

In codebook based transmission, only one SRS resource may be indicated from an SRS resource set, based on an SRI. Except for a case where the higher layer parameter “ul-FullPowerTransmission” is configured at “fullpowerMode2,” the maximum number of SRS resources configured for codebook based transmission is two. When an aperiodic SRS is configured for the UE, an SRS request field of DCI triggers transmission of an aperiodic SRS resource.

Except for a case where the higher layer parameter “ul-FullPowerTransmission” is configured at “fullpowerMode2,” when a plurality of SRS resources are configured at “codebook” by SRS-ResourceSet, the UE expects that a higher layer parameter “nrofSRS-Port” of SRS-Resource in SRS-ResourceSet is configured at the same value for all the SRS resources.

When the higher layer parameter “ul-FullPowerTransmission” is configured at “fullpowerMode2,” (1) to (3) below are applied. (1) The UE can configure one SRS resource or a plurality 4 SRS resources having the same number of or different numbers of SRS ports, in an SRS resource set having usage configured at “codebook.”

(2) When a plurality of SRS resources are configured in an SRS resource set, two different spatial relations at maximum can be configured for all the SRS resources in an SRS resource set having usage configured at “codebook.”
(3) Two or four SRS resources are supported at maximum in an SRS resource set having usage configured at “codebook” according to the capability of the UE.

In a case of a normal codebook based PUSCH, one SRS resource set having two SRS resources having the same number of ports can be configured. In a case of codebook based PUSCH repetition (for multi-transmission/reception points (TRPs)), two SRS resource sets having the same number of SRS resources may be configured for each repetition. In a case of “fullpowerMode2” in codebook based, one SRS resource set and SRS resources of the same number of ports or different numbers of ports can be configured.

### Transmission of More Than Four Antenna Ports

In Rel-15/16 NR, uplink (UL) Multi Input Multi Output (MIMO) transmission of up to four layers is supported. For future radio communication systems, it is studied to support UL transmission with layers the number of which is more than four, to achieve higher spectrum efficiency. For example, for Rel-18 NR, 6-rank maximum transmission using six antenna ports, 6-rank or 8-rank transmission using eight antenna ports, and the like are studied.

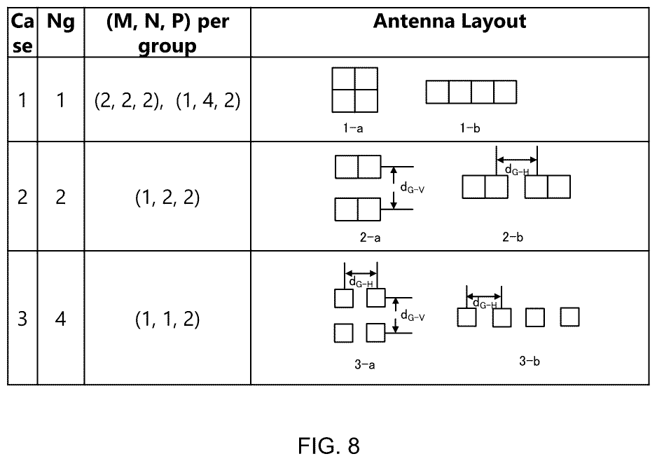

FIG. 8 is a diagram to show examples of an antenna layout with eight antenna ports. Ng denotes the number of antenna groups. M denotes the number of first dimension antennas (or antenna elements), and N denotes the number of second dimension antennas (or antenna elements). The first dimension and the second dimension are a horizontal direction and a vertical direction, for example. P denotes the number of polarization planes. A case of P=2 corresponds to a cross-polarization antenna.

An antenna group may be referred to as a coherent group. A coherent group may include one or more coherent ports. For example, a partial-coherent UE may have a plurality of coherent groups. Antenna ports in a coherent group may be coherent. Antenna ports between different coherent groups need not be coherent.

Each coherent group may correspond to a different transmission panel/transmission chain (Tx chain)/SRS resource set/RS resource set/spatial relation information (spatial relation info)/joint Transmission Configuration Indication state (joint TCI state)/UL TCI state/reception TRP. Here, the SRS resource set may correspond to an SRS resource set with the codebook or non-codebook usage, in particular. Each coherent group may correspond to a different reception TRP. A coherent group may be referred to as a coherent antenna group, a port group, an antenna set, and the like.

The UE may report an antenna group(s)/ antenna layout information/the number of coherencies as UE capability information. The UE may be configured with a coherent group(s) (for example, the number of coherent groups, the number of ports included in each coherent group) by higher layer signaling.

Note that the antenna layout is not limited to those shown in FIG. 8. For example, the number of panels for which antennas are arranged, the direction of each panel, coherency of each panel/antenna (full coherent, partial coherent, non-coherent, or the like), antenna alignment in a specific direction (such as horizontal, vertical, or the like), and a polarization antenna configuration (single polarization, cross-polarization, the number of polarization planes, or the like) may be different from those in the examples in FIGS. 7A and 7B. dG-H and dG-V respectively denote the horizontal distance and the vertical distance between centers of adjacent antenna groups.

In Rel-15/16 NR, transmission of one codeword (CW) in one PUSCH is supported. However, for Rel-18 NR, it is studied that a UE transmits more than one CW in one PUSCH. For example, support of 2CW transmission for ranks 5 to 8, support of 2CW transmission for ranks 2 to 8, and the like are studied.

A UE of Rel. 15 or Rel. 16 assumes only one beam/panel is used for UL transmission in a time period. However, in Rel. 17 or later versions, for improvement of UL throughput and reliability, multi-beam/multi-panel simultaneous UL transmission (for example, PUSCH transmission) for one or more TRPs is studied. Note that the multi-beam/multi-panel simultaneous PUSCH transmission may correspond to PUSCH transmission with the number of layers being larger than four, or may correspond to PUSCH transmission with the number of layers being four or less.

A precoding matrix for UL transmission using more than four antenna ports (the number of antenna ports being larger than four) is studied. For example, a codebook for 8-port transmission (which may be referred to as an 8-transmission UL codebook (8TX UL codebook) and the like) is studied.

### One Precoding Information Field

In previous specifications, as shown in FIG. 6, one value of the number of layers (up to four layers) and one TPMI index can be indicated to a UE by one precoding information field. For antenna port transmission with more than four antenna ports, it is studied to indicate one value of the number of layers (up to eight layers) and one TPMI index to a UE by one precoding information field by using a table different from that in FIG. 6. In this case, by defining a table with the rank larger than four for a table of precoding matrices W as that shown in FIGS. 1, 8-port transmission can be performed based on the number of layers and the TPMI index thus notified.

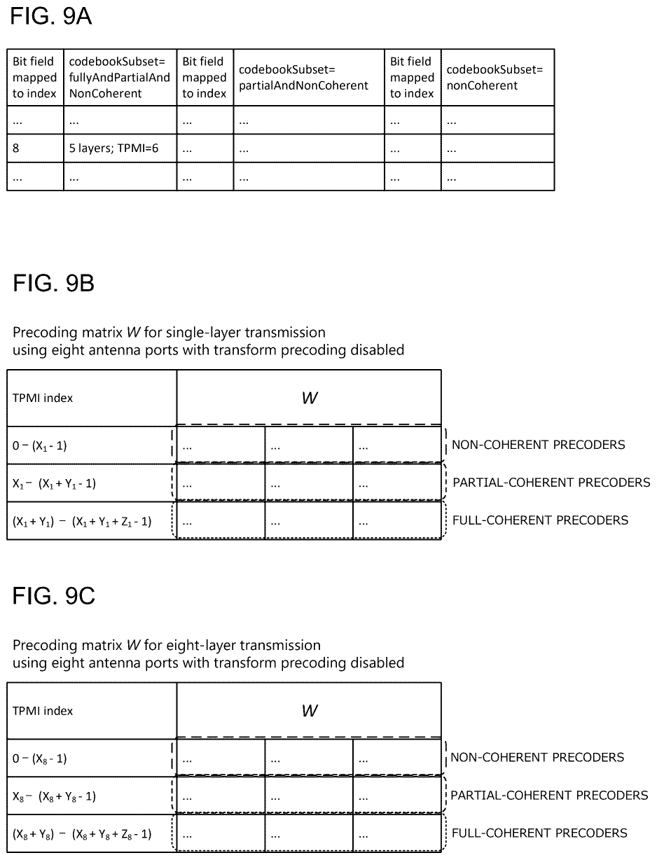

FIGS. 9A to 9C are diagrams to show examples of implementation of 8-port transmission.

FIG. 9A is a diagram to show an example of a correspondence between values of a precoding information and number of layers field and the numbers of layers and TPMIs. The correspondence of this example is a correspondence for eight antenna ports in a case where a transform precoder is configured at disabled, the maximum rank (maxRank) is configured at a value of 5 or larger, and also uplink full power transmission is not configured, is configured at full power mode 2 (fullpowerMode2), or is configured at full power (fullpower), but is not restrictive. FIG. 9A is similar to FIG. 6 but is different from FIG. 6 in that the number of layers being five or more can be indicated as shown (in FIG. 9A, a UE is indicated with the number of layers being 5 and TPMI=6, by a field value=8 in a case where a fully-coherent (fullyAndPartialAndNonCoherent) codebook subset is configured).

FIGS. 9B and 9C are diagrams to show examples of a table of precoding matrices W for 1-layer and 8-layer (rank 1 and rank 8) transmission using eight antenna ports when transform precoding is disabled.

In this example (and subsequent similar drawings), Xᵢ (i denotes the number of layers) denotes the number of non-coherent precoders for the number i of layers, Yᵢ denotes the number of partial-coherent precoders for the number i of layers, and Zᵢ denotes the number of fully-coherent precoders for the number i of layers.

(Xᵢ+Yᵢ+Zᵢ) precoders are included in a codebook for i layer(s). Based on the codebook, a non-coherent UE can refer to Xᵢ precoder(s) according to a TPMI index (0 to X₁−1), a partial-coherent UE can refer to (Xᵢ+Yᵢ) precoders according to a TPMI index (0 to X₁+Yᵢ−1), and a full-coherent UE can refer to (Xᵢ+Yᵢ+Zᵢ) precoders according to a TPMI index (0 to X₁+Yᵢ+Zᵢ−1).

### Plurality of Precoding Information Fields

Meanwhile, it is studied to include a plurality of precoding information fields (which may be referred to as enhanced TPMI fields and the like) in DCI to indicate a plurality of combinations of one value of the number of layers (up to four layers) and one TPMI index, to a UE. Each precoding information field may be associated with a coherent group.

In this case, the UE may reuse an existing 2-port or 4-port UL precoder of Rel. 15/16 to configure a new 8-port UL precoder. Examples will be described below by using drawings. Note that expressions using existing precoders W_{4TX}, W_{2TX}, and W₀ are also shown in these drawings. Here, W_{4TX} means an existing 4-port UL precoder, W_{2TX} means an existing 2-port UL precoder, and Wo means a matrix with all the elements (components) being 0.

For a UE with two coherent groups, one or more existing precoders W_{4TX}/W_{2TX} may be reused to form a new 8-port precoder. For example, a UE with two coherent groups each having four ports may perform 8-port transmission in consideration of one TPMI indication per 4TX, based on two TPMI indices notified.

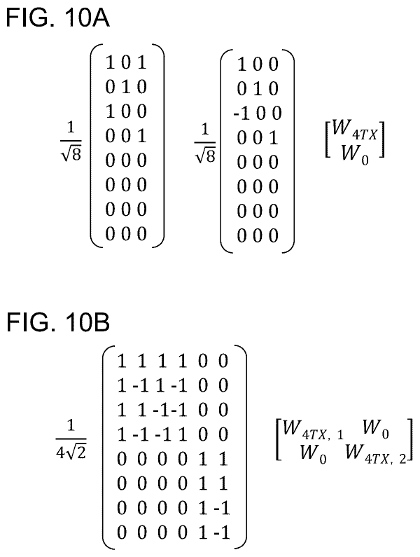

FIG. 10A is a diagram to show an example of new 3-layer precoders obtained by reusing an existing 4-port partial-coherent precoder. In FIG. 10A, for example, the existing 3-layer precoder shown in FIG. 3 is reused.

FIG. 10B is a diagram to show a 6-layer precoder constituted of four layers from one coherent group and two layers from another coherent group. In FIG. 10B, for example, the existing 2-layer and 4-layer precoders shown in FIG. 2 and FIG. 4 are reused.

In a case of a UE with four coherent groups, one, two, three, or four existing precoders W_{2TX} may be reused to form a new 8-port precoder. For example, a UE with four coherent groups each having two ports may perform 8-port transmission in consideration of one TPMI indication per 2TX, based on four TPMI indices notified.

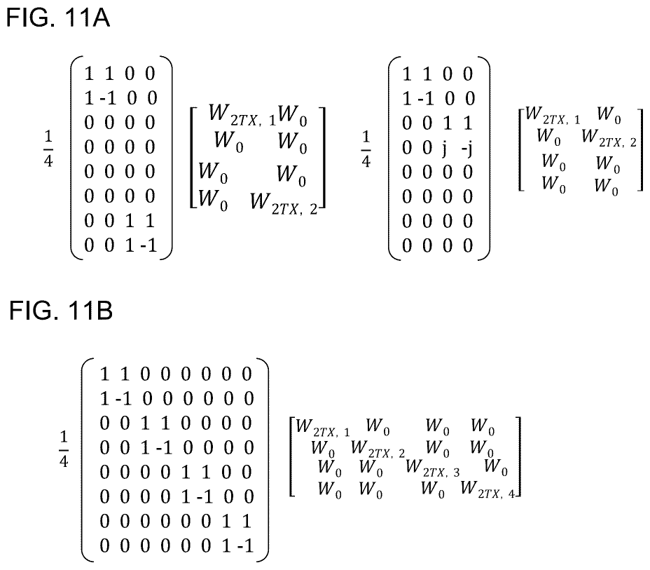

FIG. 11A is a diagram to show an example of 4-layer precoders each constituted of two layers from one coherent group and two layers from another coherent group. In FIG. 11A, for example, the existing 2-layer precoder shown in FIG. 5B is reused.

FIG. 11B is a diagram to show an example of an 8-layer precoders constituted of four two-layer precoders from four coherent groups. In FIG. 11B, for example, the existing 2-layer precoder shown in FIG. 5B is reused.

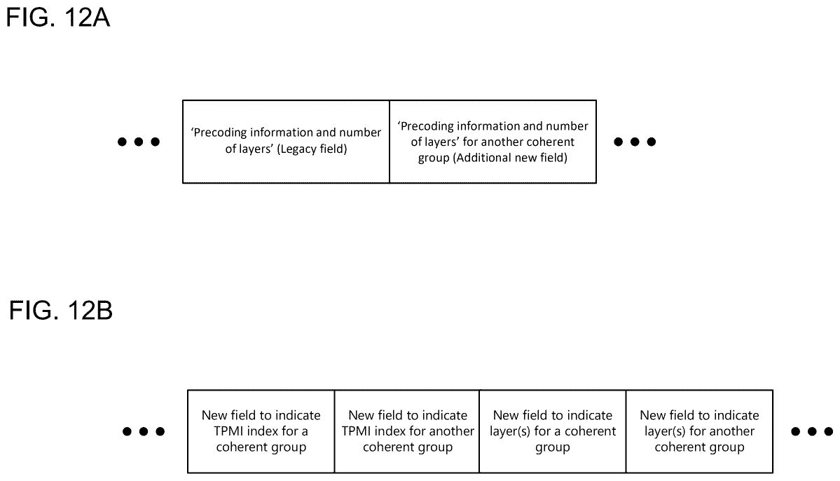

FIGS. 12A and 12B are diagrams to show examples of fields of DCI necessary to indicate a precoding matrix. In this example, examples of DCI to a UE having two coherent groups are shown.

The DCI in FIG. 12A includes a plurality of precoding information fields. Each may be similar to an existing precoding information field, but one indicates a TPMI index and the number of layers for one coherent group while the other indicates a TPMI index and the number of layers for another coherent group.

The DCI in FIG. 12B includes a plurality of pairs of a new field indicating a TPMI index (which may be referred to as a TPMI index field) and a new field indicating a layer(s) (which may be the number of layers or rank) (which may be referred to as a layer indication field). One pair indicates a TPMI index and the number of layers for one coherent group while the other pair indicates a TPMI index and the number of layers for another coherent group. The precoding information fields in the DCI in FIG. 12B need not be used for PUSCH transmission.

### Indication of Combination of the Numbers of Layers by Using One Precoding Information Field

It is also studied to indicate the number of layers for each coherent group (also referred to as a combination of the numbers of layers) while DCI includes one precoding information field as in an existing mode.

The precoding information field may indicate the number of layers for each coherent group (also referred to as a combination of the numbers of layers) and one TPMI index. This precoding information field may be applied only to a partial-coherent UE.

For example, a UE with two coherent groups may be indicated with two numbers of layers (each of which does not exceed four) and one TPMI index. A UE with four coherent groups may be indicated with four numbers of layers (each of which does not exceed two) and one TPMI index.

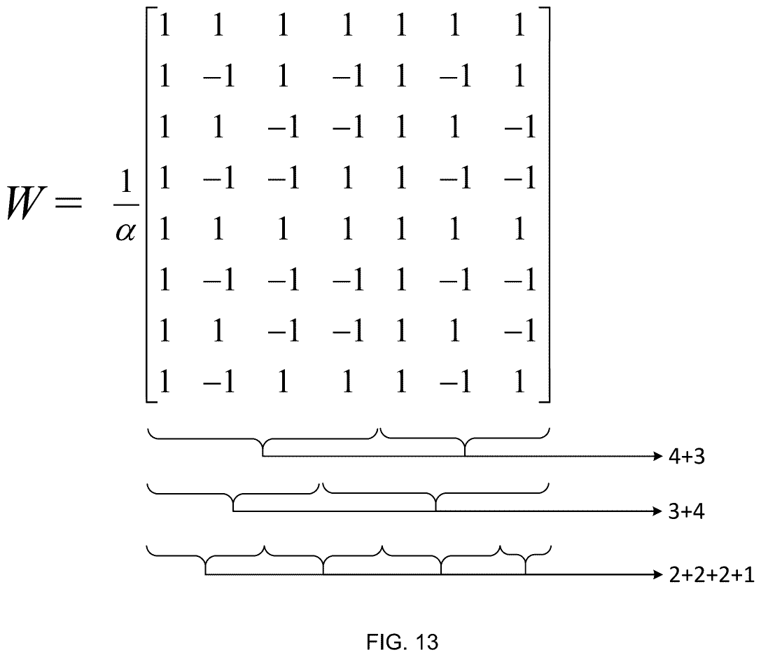

FIG. 13 is a diagram to show examples of a combination of the numbers of layers corresponding to a precoding matrix. As shown in FIG. 13, one precoding matrix W may have different numbers (combinations) of layers to divide for respective coherent groups such as 4+3, 3+4, and 2+2+2+1.

A correspondence between (for example, a table of) values of a precoding information field and combinations of the numbers of layers and TPMI indices may be defined. A UE may determine combinations of the numbers of layers and a TPMI index corresponding to an indicated precoding information field, based on the correspondence.

Note that this correspondence may include associations (rows, entries) of different combinations of the numbers of layers for the same TPMI index.

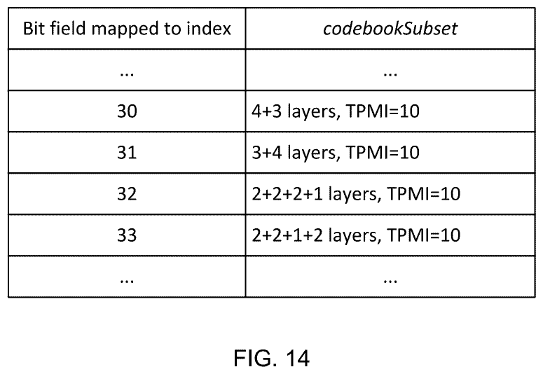

FIG. 14 is a diagram to show an example of a correspondence between values of a precoding information field and combinations of the numbers of layers and TPMI indices. In this example, as combinations of the numbers of layers, 4+3, 3+4, 2+2+2+1, and 2+2+1+2 are associated with the TPMI index=10 (indicating a precoder for seven layers) in the values of 30 to 33 of the precoding information field.

Note that, in the present disclosure, the order of coherent group application for each combination of the numbers of layers may be defined in advance, or a UE may be notified of the order by using higher layer signaling/physical layer signaling. For example, the combination 4+3 of the numbers of layers may indicate four layers for the first coherent group and three layers for the second coherent group.

Note that the correspondence as that in FIG. 14 may be applied to a full coherent UE, a non-coherent UE, and a partial-coherent UE. For example, when the values 30 to 33 of the precoding information field in FIG. 14 are indicated, a full coherent UE and a non-coherent UE may determine that the number of layers being 7, which is the total of a combination of the numbers of layers, is indicated.

The correspondence as that in FIG. 14 may be expressed by one common table or separate tables according to different UE capabilities (capabilities of coherent groups). For example, a UE with two coherent groups may refer to a table with columns each indicating a combination of two numbers of layers as the values 30 and 31 of the precoding information field in FIG. 14, and a UE with four coherent groups may refer to a table with columns each indicating a combination of four numbers of layers as the values 32 and 33 of the precoding information field in FIG. 14.

It is also studied to indicate the (total) number of layers by using one precoding information field included in DCI and further indicate a combination of the numbers of layers by using a new field included in the DCI.

In this case, each precoding information field value included in the DCI is associated only with the number of layers (total number of layers) as those shown in FIG. 6. Meanwhile, the DCI includes a new field related to a combination of the numbers of layers corresponding to a certain number of layers if indicated (also referred to as an indication field for a combination of numbers of layers of different coherent group, a rank combination indication field, and the like, below). A UE may determine a combination of the numbers of layers, based on a rank combination indication field and the indicated number of layers.

The rank combination indication field may be applied only to a partial-coherent UE and may be included only in DCI for a partial-coherent UE.

A correspondence between (for example a table of) values of a rank combination indication field and combinations of the numbers of layers for respective layers may be defined. Note that this correspondence may be defined for each number of coherent groups. This correspondence may be defined for all the numbers of layers (for example, one to eight layers) or may be defined for part of the numbers of layers (for example, the numbers of layers being larger than four). In other words, this correspondence may be different for each number of layers.

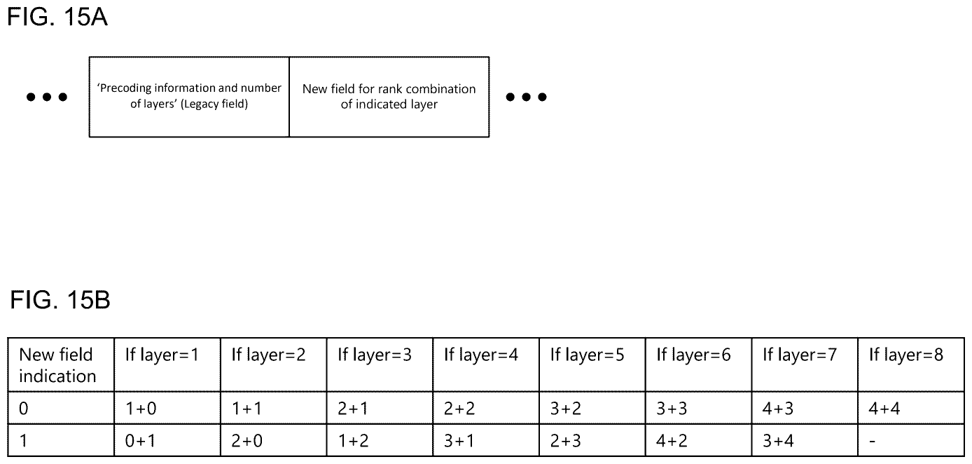

FIG. 15A is a diagram to show an example of fields of DCI necessary to indicate a precoding matrix. The DCI in FIG. 15A includes one precoding information field and one rank combination indication field.

FIG. 15B is a diagram to show an example of a correspondence between values of a rank combination indication field and combinations of the numbers of layers. FIG. 15B shows a correspondence for an 8Tx UE with two coherent groups. “New field indication” in FIG. 15B corresponds to values of the rank combination indication field.

For example, a UE indicated with seven layers by the precoding information field may determine that the combination of the numbers of layers is 4+3 if the rank combination indication field is 0 (=0) while determining that the combination of the numbers of layers is 3+4 if the rank combination indication field is 1 (=1).

Note that some combinations (for example, 1+0, 0+1, 2+0, and the like) need not be defined.

### Analysis

In existing standards and studies described above, it is assumed that a full-coherent UE is configured with a fully/partially/non-coherent precoder by a different codebook subset (“fullyAndPartialAndNonCoherent,” “partialAndNonCoherent,” or “nonCoherent”), and a partial-coherent UE is configured with a partially/non-coherent precoder by a different codebook subset (“partialAndNonCoherent” or “nonCoherent”).

To support this assumption, support of unified design of a precoding matrix table (codebook), unified design of DCI notification of an SRI/TPMI/RI, and the like is needed.

However, the inventors of the present invention focused that a preferable codebook configuration, a preferable method of indicating a precoding matrix W, and the like are different depending on a different precoder type. Such unified design described above, for example, limits individual preferable configurations of precoding matrices and causes an increase in bit size of DCI notification, which may suppress an increase in communication throughput.

Thus, the inventors of the present invention came up with the idea of a method for appropriately performing UL transmission using more than four antenna ports.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C.”

In the present disclosure, notify, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, a TPMI and a TPMI index may be interchangeably interpreted. A port and an antenna port may be interchangeably interpreted. 8TX (8 transmission) may mean eight port or eight antenna ports. A port/antenna port may mean a port/antenna port for UL (for example, SRS/PUSCH) transmission. In the present disclosure, an SRS resource set and a resource set may be interchangeably interpreted. A coherent group and an SRS resource set may be interchangeably interpreted.

In the present disclosure, 8TX will be mainly described. However, the description may be applied to 5TX, 6TX, 7TX, 8 or more TX, 4 or less TX, and the like similarly to the case of 8TX. “8” in the embodiments below may be interpreted as “n (n is any integer).” In this case, the number of layers/number of ports described by assuming that the maximum value is “8” can be appropriately interpreted by assuming that the maximum number is “n” by those skilled in the art.

Note that, in the present disclosure, “having a capability of . . . ” and “supporting/reporting a capability of . . . ” may be interchangeably interpreted.

In the present disclosure, a rank, a transmission rank, the number of layers, and the number of antenna ports may be interchangeably interpreted. One codeword being applied and the number of layers being four layers or less may be interchangeably interpreted. Two codewords being applied and the number of layers being more than four layers may be interchangeably interpreted.

In the present disclosure, one table and a plurality of tables may be interchangeably interpreted.

DCI in the embodiments below may mean DCI for scheduling at least one of a PUSCH and a PDSCH (for example, DCI format 0_x, 1_x (here, x is an integer)). In the embodiments below, codebook based transmission (PUSCH) is assumed, but this is not restrictive.

### Radio Communication Method

### <First Embodiment>

A first embodiment relates to a configuration of a new codebook subset for 8TX UE.

A new codebook subset may include at least one of a codebook subset only for fully-coherent precoder and a codebook subset only for partial-coherent precoder. The new codebook subset may include a codebook subset only for non-coherent precoder. In other words, the new codebook subset may mean a codebook subset for single coherency (or single coherent).

For example, a full-coherent UE may be configured with configuration information indicating a codebook subset only for fully-coherent precoder (for example, an RRC parameter “codebookSubset” indicating “fullyCoherent” or “fullyCoherentOnly”).

A partial-coherent UE may be configured with configuration information indicating a codebook subset only for partial-coherent precoder (for example, an RRC parameter “codebookSubset” indicating “partialCoherent” or “partialCoherentOnly”).

A UE may be configured with only one new codebook subset. A UE may be configured with only one codebook subset at one time among a codebook subset only for fully-coherent precoder (fullyCoherent), a codebook subset only for partial-coherent precoder (partialCoherent), and a codebook subset only for non-coherent precoder (nonCoherent).

For example, a full-coherent UE may be configured with a codebook subset only for fully-coherent precoder, a codebook subset only for partial-coherent precoder, or a codebook only for non-coherent precoder.

A partial-coherent UE may be configured with a codebook subset only for partial-coherent precoder or a codebook subset only for non-coherent precoder.

A UE need not expect to be configured with more than one new codebook subset.

Note that a fully-coherent UE need not expect to be configured with a codebook subset only for partial-coherent precoder. A partial-coherent UE may be configured with both a codebook subset only for fully-coherent precoder and a codebook subset only for partial-coherent precoder (simultaneously).

### {UE Capability for New Codebook Subset}

A UE may report a UE capability for a new codebook subset. The UE capability may include information indicating support of a codebook subset only for fully-coherent precoder (for example, “fullCoherentOnly”), information indicating support of a codebook subset only for partial-coherent precoder (for example, “partialCoherentOnly”), or the like.

Note that a function of supporting a fully/partial/non-coherent codebook subset (for example, capability reported by pusch-TransCoherence indicating full coherent (fullCoherent)) may be an assumption of a function of supporting the codebook subset only for fully-coherent precoder. In other words, a UE that supports a codebook subset only for fully-coherent precoder may inevitably support a fully/partial/non-coherent codebook subset.

In this case, a UE that supports full coherent (fullCoherent) may support a fully/partial/non-coherent codebook subset and may be configured with a codebook subset of “fullyAndPartialAndNonCoherent” by a base station. A UE that supports only full coherent (fullCoherentOnly) may be configured with either a codebook subset of “fullyAndPartialAndNonCoherent” or a codebook subset only for fully-coherent precoder (fullyCoherent) by a base station.

Alternatively, a function of supporting a codebook subset only for fully-coherent precoder may be an assumption of a function of supporting a fully/partial/non-coherent codebook subset. In other words, a UE that supports a codebook subset for fully/partial/non-coherent codebook subset may inevitably support a codebook subset only for fully-coherent precoder.

In this case, a UE that supports full coherent (fullCoherent) may be configured with either a codebook subset of “fullyAndPartialAndNonCoherent” or a codebook subset only for fully-coherent precoder (fullyCoherent) by a base station. A UE that supports only full coherent (fullCoherentOnly) may be configured with a codebook subset only for fully-coherent precoder (fullyCoherent) by a base station.

Note that a UE may independently report a function of supporting a codebook subset only for fully-coherent precoder and a function of supporting a fully/partial/non-coherent codebook subset.

In this case, a UE that supports full coherent (fullCoherent) may be configured with a codebook subset of “fullyAndPartialAndNonCoherent” by a base station. A UE that supports only full coherent (fullCoherentOnly) may be configured with a codebook subset only for fully-coherent precoder (fullyCoherent) by a base station.

According to the first embodiment, for example, by a full-coherent UE or a partial-coherent UE being configured with a codebook subset only for corresponding precoder (or only one new codebook subset), a correspondence of a precoding information field of DCI can be made specific to each different coherent type, which can simplify design of a DCI indication to allow reduction in the field size and the like to be expected. Particularly to stationary terminals such as a customer-provided equipment (CPE) and a fixed wireless access (FWA) terminal, limiting codebook subsets to be used as described above is allowed.

### <Second Embodiment>

A second embodiment relates to a precoding matrix table (codebook).

As shown in FIGS. 2 to 5, for example, an existing codebook includes a plurality of (all corresponding) coherent precoders according to TPMI indices.

In the second embodiment, a different codebook (table of precoding matrices) is defined for each coherent type (for example, each coherent type of a UE/configured codebook subset type).

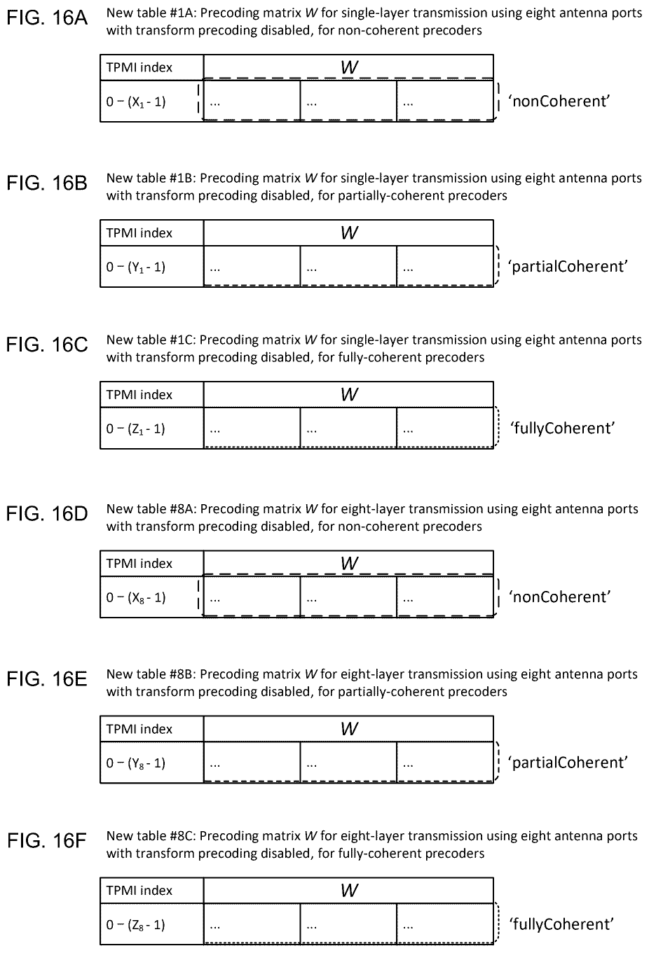

FIGS. 16A to 16C are diagrams to show examples of a table of precoding matrices W for 1-layer (rank 1) transmission using eight antenna ports when transform precoding is disabled, according to the second embodiment. FIGS. 16A, 16B, and 16C correspond to respective cases where a UE is configured with a codebook subset only for non-coherent precoder (nonCoherent), a codebook subset only for partial-coherent precoder (partialCoherent), and a codebook subset only for fully-coherent precoder (fullyCoherent).

FIGS. 16D to 16F are diagrams to show examples of a table of precoding matrices W for 8-layer (rank 8) transmission using eight antenna ports when transform precoding is disabled, according to the second embodiment. FIGS. 16D, 16E, and 16F correspond to respective cases where a UE is configured with a codebook subset only for non-coherent precoder (nonCoherent), a codebook subset only for partial-coherent precoder (partialCoherent), and a codebook subset only for fully-coherent precoder (fullyCoherent).

In this example, a codebook for non-coherent precoder for i layer(s) includes X precoder(s), and a non-coherent UE can refer to the X; precoder(s) according to a TPMI index, based on the codebook. A codebook for partial-coherent precoder for i layer(s) includes Yᵢ precoder(s), and a partial-coherent UE can refer to the Yᵢ precoder(s) according to a TPMI index, based on the codebook. A codebook for fully-coherent precoder for i layer(s) includes Zᵢ precoder(s), and a full-coherent UE can refer to the Zᵢ precoder(s) according to a TPMI index, based on the codebook.

For convenience, a table for a codebook for non-coherent precoder for i layer(s) is referred to as table #iA, a table for a codebook for a partial-coherent precoder for i layer(s) is referred to as table #iB, and a table for a codebook for fully-coherent precoder for i layer(s) is referred to as table #iC. In each table, TPMI indices may start from 0.

Note that, instead of tables to be used being separated for respective new codebook subsets as shown in FIGS. 16A to 16F, one table including fully/partial/non-coherent precoders as shown in FIGS. 9B and 9C may be used commonly for new codebook subsets.

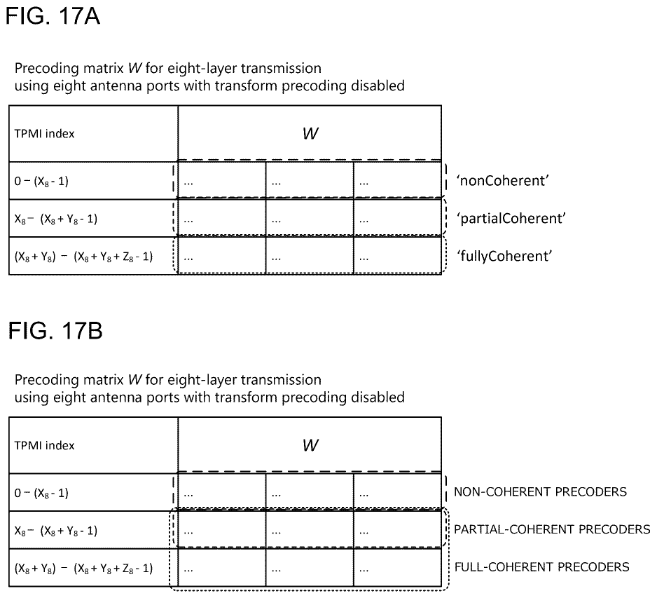

FIGS. 17A and 17B are diagrams to show examples of a table of precoding matrices W for 8-layer (rank 8) transmission using eight antenna ports when transform precoding is disabled, according to the second embodiment. In this example, similarly to FIGS. 9B and 9C, (Xᵢ+Yᵢ+Zᵢ) precoders are included in a codebook for i layer(s).

In the example in FIG. 17A, a UE configured with a codebook subset only for non-coherent precoder (nonCoherent) can refer only to Xᵢ non-coherent precoder(s) according to a TPMI index (0 to X₁−1). A UE configured with a codebook subset only for partial-coherent precoder (partialCoherent) can refer to Yᵢ precoder(s) according to a TPMI index (X₁ to X₁+Yᵢ−1). A UE configured with a codebook subset only for non-coherent precoder (fullyCoherent) can refer to Zᵢ precoder(s) according to a TPMI index (X₁+Yᵢ to X₁+Yᵢ+Zᵢ−1).

In the example in FIG. 17A, for example, a UE configured with a codebook subset only for fully-coherent precoder (fullyCoherent) may assume that the precoding information field has a size of at least log₂Zᵢ or larger and need not assume that the precoding information field has a size of log₂ (X₁+Yᵢ+Zᵢ) or larger.

The example in FIG. 17B shows an example where a base station can notify a full-coherent UE (for example, a UE configured with a codebook subset of “fully/partial/non-coherent” (fullyAndPartialAndNonCoherent) of a full/partial-coherent TPMI (TPMI indicating a fully/partial-coherent precoder) while not notifying the full-coherent UE of a non-coherent TPMI. Since a base station can notify a full-coherent UE of a full/partial/non-coherent TPMI in existing NR, a precoding information field need to have the number of bits possible to notify the UE of all the TPMIs. However, in the case of FIG. 17B, the size of a precoding information field for a full-coherent UE can be reduced.

Note that operation that a base station can notify a full-coherent UE of a full/non-coherent TPMI while not notifying the UE of a partial-coherent TPMI may be performed for the full-coherent UE. A base station may notify a partial-coherent UE of a partial/non-coherent TPMI.

According to the second embodiment, a UE configured with a new codebook subset can refer to an appropriate table to determine a precoding matrix.

### <Third Embodiment>

A third embodiment relates to contents specified by a precoding information field.

In existing NR, for example, as shown in FIG. 6, a correspondence between (for example, a table of) values of a precoding information field and the numbers of layers and TPMIs are specified according to a codebook subset configured for a UE. The UE determines the number of layers and a TPMI index corresponding to an indicated precoding information field, based on the correspondence. The UE determines a table (codebook) to refer to, to determine a precoding matrix, based on the number of layers. In existing NR, this correspondence cannot be associated with a codebook only for fully-coherent precoder, a codebook only for partial-coherent precoder, and the like.

In the third embodiment, the correspondence above is newly defined separately for each coherent type/precoder (for example, each coherent type of a UE/configured codebook subset type).

For a non-coherent UE/precoder/codebook subset, such a new correspondence may include rows indicating the numbers of layers and TPMI indices (in a table of 1-layer to 8-layer precoding matrices only for non-coherent precoder).

Note that, in the present disclosure, a correspondence including a row may mean that an index for the correspondence (column index, for example, a value of a precoding matrix field) is associated with an entry (or element, for example, the number of layers, a TPMI index) indicated by the row.

For a full-coherent UE/fully-coherent precoder/fully-coherent codebook subset, a new correspondence may include at least one of the following:
combinations between the numbers of layers and a TPMI index (in a table of 1-layer to 8-layer precoding matrices only for fully-coherent precoder)
combinations between the number of layers and a set (i_{1,1}, i_{1,2}, i₂, and i_{1,3}).

Here, the set (i_{1,1}, i_{1,2}, i₂, and i_{1,3}) may be used, for example, when a precoder W of a DL type I single-panel codebook is used as an 8TX UL fully-coherent precoder, to specify the precoder. These indices i_{1,1}, i_{1,2}, i₂, and i_{1,3} may have the same definitions as those related to the DL type I single-panel codebook.

For a partial-coherent UE/precoder/codebook subset, a new correspondence may include at least one of the following:
combinations between the numbers of layer and a TPMI index (in a table of 1-layer to 8-layer precoding matrices only for partial-coherent precoder)
combinations of a combination of the number of layers (for different coherent groups) and one TPMI index
a plurality of the numbers of layers/plurality of TPMI indices (for different coherent groups)

Note that no new correspondence need be defined for a partial-coherent UE/partial-coherent precoder/partial-coherent codebook subset. In this case, for example, a partial-coherent UE may reuse one or more existing precoders W_{4TX}/W_{2TX} to specify an 8-port precoder. As shown in relation to FIG. 12A/12B, a UE may use a plurality of precoding information fields/TPMI index fields/layer indication fields included in DCI, for determination of W_{4TX}/W_{2TX}.

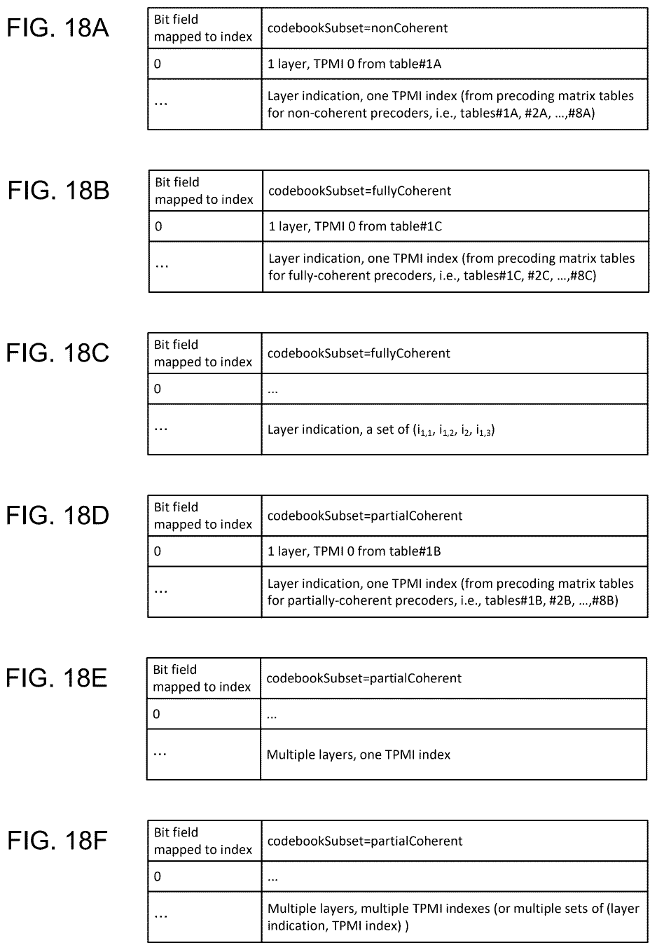

FIGS. 18A to 18F are diagrams to show examples of a correspondence between values of a precoding information and number of layers field and specified contents, according to the third embodiment. The correspondence of this example is a correspondence for eight antenna ports in a case where a transform precoder is configured at disabled, the maximum rank (maxRank) is configured at up to 8, and also uplink full power transmission is not configured, is configured at full power mode 2 (fullpowerMode2), or is configured at full power (fullpower), but is not restrictive.

FIG. 18A shows a correspondence for a UE configured with a codebook subset only for non-coherent precoder (nonCoherent). In the correspondence in FIG. 18A, an indication of the number of layers and a corresponding TPMI index are specified. The TPMI index indicates a TPMI index in table #iA, and this i corresponds to the indication of the number of layers.

FIGS. 18B and 18C show correspondences for a UE configured with a codebook subset only for fully-coherent precoder (fullyCoherent). In the correspondence in FIG. 18B, an indication of the number of layers and a corresponding TPMI index are specified. The TPMI index indicates a TPMI index in table #iC, and this i corresponds to the indication of the number of layers. In the correspondence in FIG. 18C, an indication of the number of layers and (i_{1,1}, i_{1,2}, i₂, and i_{1,3}) are specified.

FIGS. 18D to 18F show correspondences for a UE configured with a codebook subset only for partial-coherent precoder (partialCoherent). In the correspondence in FIG. 18D, an indication of the number of layers and a corresponding TPMI index are specified. The TPMI index indicates a TPMI index in table #iB, and this i corresponds to the indication of the number of layers. In the correspondence in FIG. 18E, a plurality of layers (combination of the numbers of layers) and one TPMI index are specified. In the correspondence in FIG. 18F, a plurality of layers (combination of the numbers of layers) and a plurality of TPMI indices (or a plurality of sets of an indication of the number of layers and a TPMI index) are specified.

Note that a codebook subset only for non/partially/fully-coherent precoder being configured and a codebook subset only for non-/partially/fully-coherent precoder being indicated by DCI/MAC CE may be interchangeably interpreted. This is because the examples in FIGS. 18A to 18F are appropriate in a case where a UE can be configured with only one new codebook subset but cannot be directly used in a case where a UE can be configured with a plurality of codebook subsets and is indicated with any of the plurality of new codebook subsets by using a field of DCI (which may be referred to as a codebook subset indication field and the like, for example)/MAC CE.

The correspondences of the respective coherent types may be defined together in one table as that shown in FIG. 6.

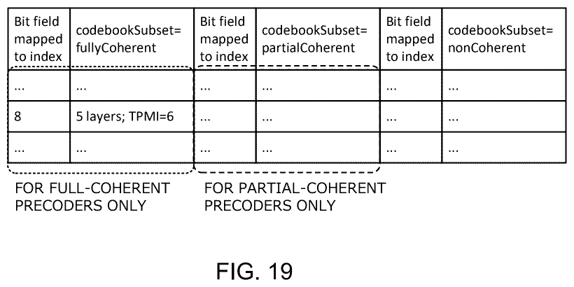

FIG. 19 is a diagram to show an example of a correspondence between values of a precoding information and number of layers field and specified contents, according to the third embodiment.

The correspondence of this example corresponds to a table obtained by replacing a fully-coherent codebook subset (fullyAndPartialAndNonCoherent) in FIG. 6 with a codebook subset only for fully-coherent precoder (fullyCoherent) and replacing a partial-coherent codebook subset (partialAndNonCoherent) in FIG. 6 with a codebook subset only for partial-coherent precoder (partialCoherent). Note that the numbers of bits in a bit field mapped to an index may be different from those in FIG. 6.

The part only for fully-coherent precoder in the correspondence in FIG. 19 may correspond to the correspondence in FIG. 18A. The part only for partial-coherent precoder in the correspondence in FIG. 19 may correspond to the correspondence in FIG. 18B/18C. The part only for non-coherent precoder in the correspondence in FIG. 19 may correspond to the correspondence in FIG. 18D/18E/18F.

According to the third embodiment, a UE can appropriately grasp a precoding matrix table to refer to, based on a precoding information field.

### Supplement

In the present disclosure, a UE/base station using (/referring to/performing processing based on) a table may not only mean using the table itself but also may mean using a sequence, a list, a function, or the like including information according to the table.

Note that “-rXX” in the present disclosure indicates a parameter defined or to be defined in 3GPP Rel. XX. The name of any parameter in the present disclosure is not limited to any name illustrated (for example, “-rXX” need not be included, “-rXX” may be attached, or a different number or character may be used for XX). A 3GPP release to which the present disclosure is applied is not limited to Rel. 18.

### {Notification of Information to UE}

Any notification of information (from a network (NW) (for example, a base station (BS))) to a UE (in other words, any reception, in a UE, of information from a BS) in the above-described embodiments may be performed by using physical layer signaling (for example, DCI), higher layer signaling (for example, RRC signaling, a MAC CE), a specific signal/channel (for example, a PDCCH, a PDSCH, a reference signal), or combinations of these.

In a case where the notification described above is performed by the MAC CE, the MAC CE may be identified by a new logical channel ID (LCID) being included in a MAC sub-header, the new logical channel ID being not defined in an existing specification.

In a case where the notification described above is performed by the DCI, the notification described above may be performed by using a specific field of the DCI, a radio network temporary identifier (RNTI) used to scramble a cyclic redundancy check (CRC) bit attached to the DCI, a format of the DCI, and the like.

Any notification of information to a UE in the above-described embodiments may be performed periodically, semi-persistently, or aperiodically.

### {Notification of Information From UE}

Any notification of information from a UE (to a NW) (in other words, any transmission/reporting, in a UE, of information to a BS) in the above-described embodiments may be performed by using physical layer signaling (for example, UCI), higher layer signaling (for example, RRC signaling, a MAC CE), a specific signal/channel (for example, a PUCCH, a PUSCH, a PRACH, a reference signal), or combinations of these.

In a case where the notification described above is performed by the MAC CE, the MAC CE may be identified by a new LCID being included in a MAC sub-header, the new LCID being not defined in an existing specification.

In a case where the notification described above is performed by the UCI, the notification described above may be transmitted by using a PUCCH or a PUSCH.

Any notification of information from a UE in the above-described embodiments may be performed periodically, semi-persistently, or aperiodically.

### Application of Respective Embodiments

At least one of the above-described embodiments may be applied to a case where a specific condition is satisfied. The specific condition may be defined in a specification, or may be notified to the UE/BS by using higher layer signaling/physical layer signaling.

At least one of the above-described embodiments may be applied only to a UE that has reported specific UE capability or that supports the specific UE capability.

The specific UE capability may indicate at least one of the following:
supporting specific processing/operation/control/information for at least one of the above-described embodiments
supporting 8TX UL transmission
supporting a coherent group

The specific UE capability described above may be capability applied across all the frequencies (commonly regardless of frequency), capability per frequency (for example, one or combinations of a cell, a band, a band combination, a BWP, a component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or per frequency division duplex (FDD)).

At least one of the above-described embodiments may be applied to a case where specific information associated with the above-described embodiments (or operation for the above-described embodiments) is configured/activated/triggered for the UE by higher layer signaling/physical layer signaling. For example, the specific information may be information indicating enabling of 8TX UL transmission, any RRC parameter for a specific release (for example, Rel. 18/19), or the like.

In a case where the UE does not support at least one of the specific UE capability or is not configured with the specific information, the UE may apply, for example, Rel-15/16 operation.

### Supplementary Notes

Regarding one embodiment of the present disclosure, the following supplementary notes of the invention will be given.

### {Supplementary Note 1}

A terminal including:

a receiving section that receives configuration information related to a codebook subset only for a fully-coherent precoder or a codebook subset only for a partial-coherent precoder; and

a control section that determines a precoding matrix for transmission of a physical uplink shared channel, based on the codebook subset indicated by the configuration information and downlink control information for scheduling the physical uplink shared channel.

### {Supplementary Note 2}

The terminal according to supplementary note 1, wherein the control section determines the precoding matrix, based on a field included in the downlink control information, with reference to a codebook including only a coherent precoder corresponding to the codebook subset indicated by the configuration information.

### {Supplementary Note 3}

The terminal according to supplementary note 1 or 2, wherein the control section does not refer to a codebook other than the codebook including only the coherent precoder corresponding to the codebook subset indicated by the configuration information, based on the field included in the downlink control information.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

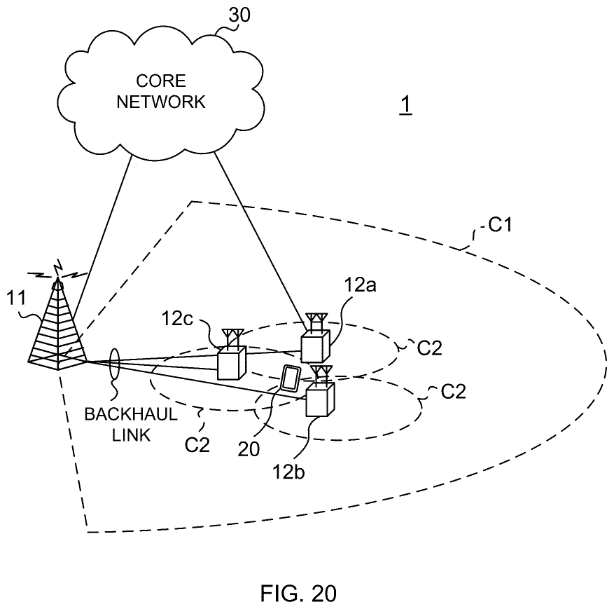

FIG. 20 is a diagram to show an example of a schematic structure of the radio communication system according to one embodiment. The radio communication system 1 (which may be simply referred to as a system 1) may be a system implementing communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHZ or less (sub-6 GHZ), and FR2 may be a frequency band which is higher than 24 GHz (above −24 GHz). Note that frequency bands, definitions and so on of FR1 and FR2 are by no means limited to these, and for example, FRI may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor, ” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF) such as a User Plane Function (UPF), an Access and Mobility management Function (AMF), a Session Management Function (SMF), Unified Data Management (UDM), an Application Function (AF), a Data Network (DN), a Location Management Function (LMF), and operation, administration, and maintenance (Management) (OAM), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block, ” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

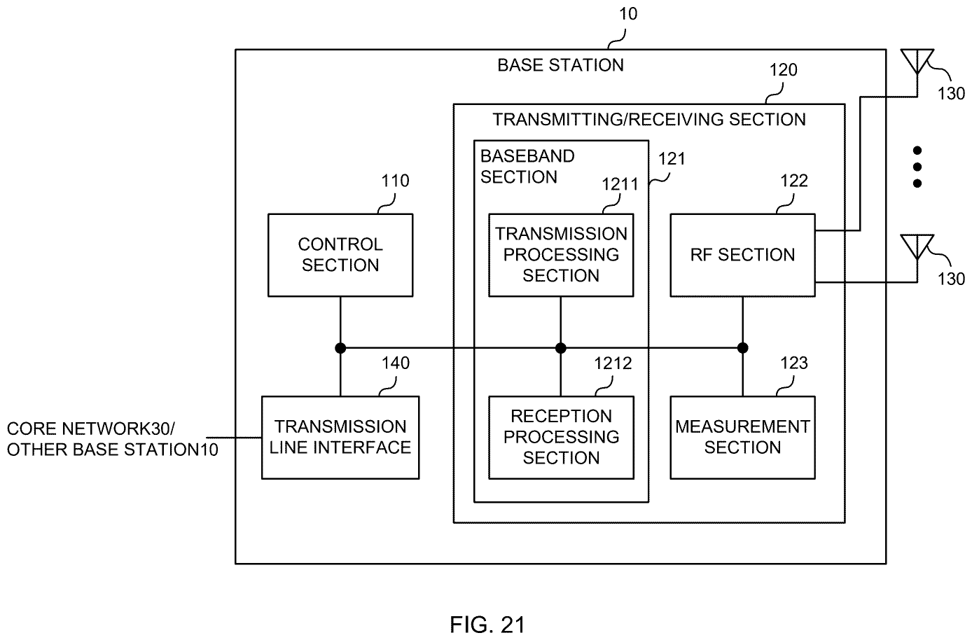

FIG. 21 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 (for example, a network node providing NF) or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit, to the user terminal 20, configuration information related to a codebook subset only for fully-coherent precoder or a codebook subset only for partial-coherent precoder. The transmitting/receiving section 120 may receive a physical uplink shared channel transmitted from the user terminal 20 by using a precoding matrix determined based on the codebook subset indicated by the configuration information and downlink control information for scheduling the physical uplink shared channel.

### User Terminal

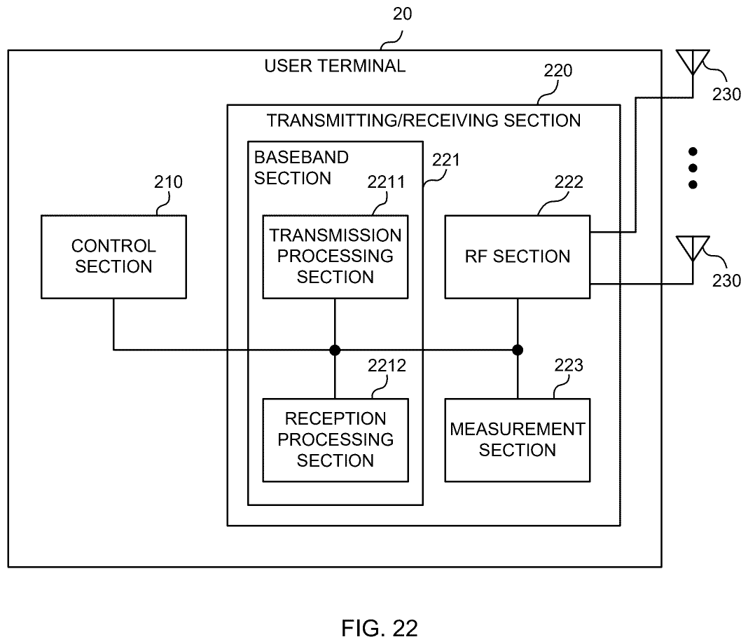

FIG. 22 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive configuration information related to a codebook subset only for fully-coherent precoder or a codebook subset only for partial-coherent precoder (for example, an RRC parameter “codebookSubset” indicating “fullyCoherent” or “partialCoherent”). The control section 210 may determine a precoding matrix for transmission of a physical uplink shared channel (PUSCH), based on the codebook subset indicated by the configuration information and downlink control information (DCI) for scheduling the physical uplink shared channel.

The control section 210 may determine the precoding matrix, based on a field included in the downlink control information, with reference to a codebook including only a coherent precoder corresponding to the codebook subset indicated by the configuration information.

The control section 210 need not refer to a codebook other than the codebook including only the coherent precoder corresponding to the codebook subset indicated by the configuration information, based on the field included in the downlink control information.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

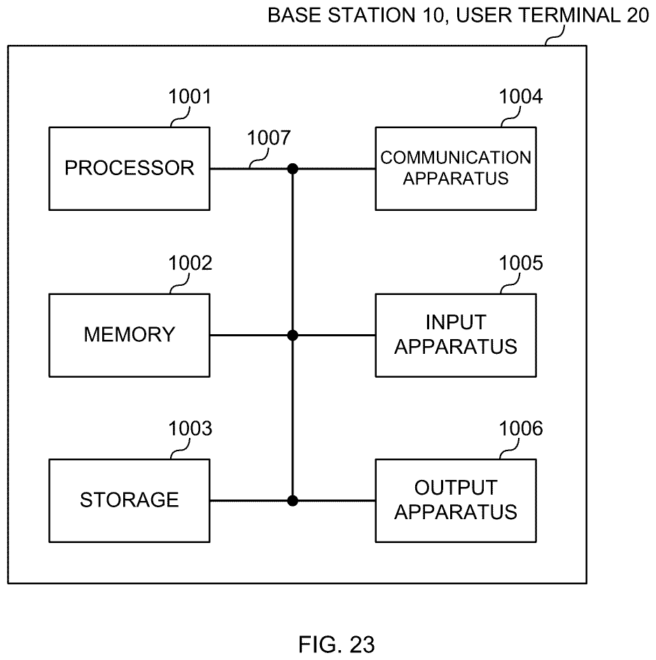

For example, a base station, a user terminal, and so on according to one embodiment of the present disclosure may function as a computer that executes the processes of the radio communication method of the present disclosure. FIG. 23 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### Variations

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of THIS is not limited to this.

The TTI may be a transmission time unit for channel-encoded data packets (transport blocks), code blocks, codewords, or the like, or may be a unit of processing in scheduling, link adaptation, or o the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIS (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CES).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, an “antenna port group”, a “layer”, “the number of layers”, a “rank”, a “resource”, a “resource set”, a “resource group”, a “beam”, a “beam width”, a “beam angular degree”, an “antenna”, an “antenna element”, a “panel”, and so on may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

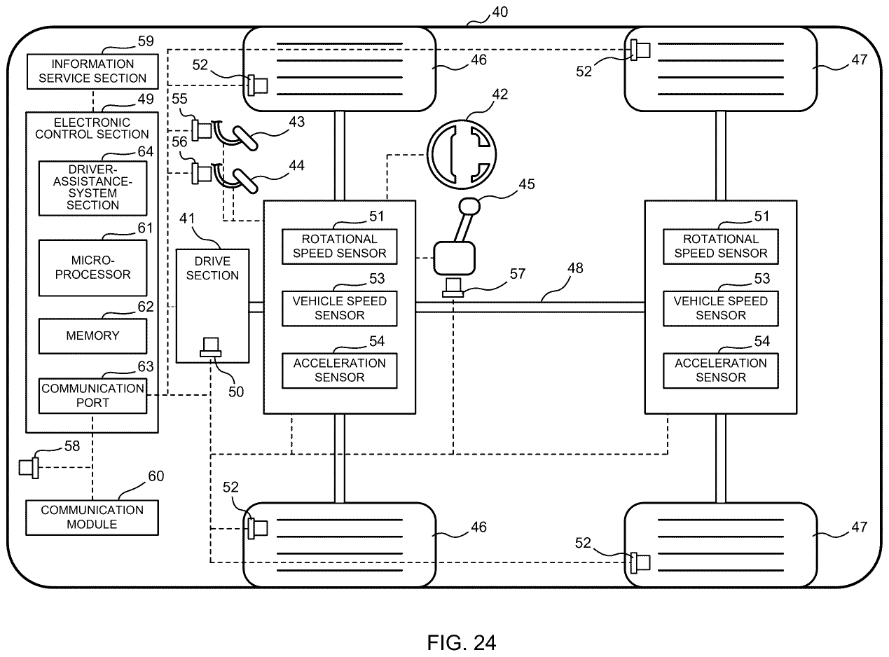

FIG. 24 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (10) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action.

“Decide/deciding (determine/determining)” may be used interchangeably with “assume/assuming”, “expect/expecting”, “consider/considering”, and the like.

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

Now, although the invention according to the present disclosure has been described in detail above, it is apparent to a person skilled in the art that the invention according to the present disclosure is by no means limited to the embodiments described in the present disclosure. Modifications, alternatives, replacements, etc., of the invention according to the present disclosure may be possible without departing from the subject matter and the scope of the present invention defined based on the descriptions of claims. The description of the present disclosure is provided only for the purpose of explaining examples, and should by no means be construed to limit the invention according to the present disclosure in any way.

1.-5. (canceled)

6. A terminal comprising:
a receiver that receives configuration information indicating any one of a codebook only for fully-coherent precoder, a codebook only for partial-coherent precoder and a codebook only for non-coherent precoder; and
a processor that determines a precoding matrix for transmission of a physical uplink shared channel based on the codebook indicated by the configuration information and downlink control information for scheduling the physical uplink shared channel.

7. The terminal according to claim 6, wherein for transmission of the physical uplink shared channel using a given number of antenna ports, the processor determines the precoding matrix with reference to the codebook indicated by the configuration information, based on a field included in the downlink control information.

8. The terminal according to claim 7, wherein the given number is 8.

9. The terminal according to claim 6, wherein the codebook only for the fully-coherent precoder, the codebook only for the partial-coherent precoder and the codebook only for the non-coherent precoder are defined by different tables each with Transmitted Precoding Matrix Indicator (TPMI) index starting with 0.

10. The terminal according to claim 6, wherein regarding the codebook only for the fully-coherent precoder, the codebook only for the partial-coherent precoder and the codebook only for the non-coherent precoder, mutually different tables are defined, each indicating relationship between precoding information and layer number field, and a number of layers and Transmitted Precoding Matrix Indicator (TPMI).

11. A radio communication method for a terminal, comprising:
receiving configuration information indicating any one of a codebook only for fully-coherent precoder, a codebook only for partial-coherent precoder and a codebook only for non-coherent precoder; and
determining a precoding matrix for transmission of a physical uplink shared channel based on the codebook indicated by the configuration information and downlink control information for scheduling the physical uplink shared channel.

12. A base station comprising:
a transmitter that transmits, to a terminal, configuration information indicating any one of a codebook only for fully-coherent precoder, a codebook only for partial-coherent precoder and a codebook only for non-coherent precoder; and
a receiver that receives a physical uplink shared channel that is transmitted from the terminal using a precoding matrix determined based on the codebook indicated by the configuration information and downlink control information for scheduling the physical uplink shared channel.

13. A system comprising: a terminal according to claim 6; and a base station according to claim 12.

14. A system comprising: a terminal according to claim 7; and a base station according to claim 12.

15. A system comprising: a terminal according to claim 8; and a base station according to claim 12.

16. A system comprising: a terminal according to claim 9; and a base station according to claim 12.

17. A system comprising: a terminal according to claim 10; and a base station according to claim 12.
